(19) United States
(12) Patent Application Publication
(10) Pub. No.: US 2007/0257109 A1
(43) Pub. Date: Nov. 8, 2007

(54) PAYMENT SYSTEM WITH OUTDOOR TERMINAL

(76) Inventors: William Johansen JR., Auburn, CA (US); Jean-Marc Delbecq, Santa Clara, CA (US); Daniel T. Ross, Los Altos, CA (US)

Correspondence Address: KOLISCH HARTWELL, P.C., 200 PACIFIC BUILDING, 520 SW YAMHILL STREET, PORTLAND, OR, 97204, US

(21) Appl. No.: 11/743,523

(22) Filed: May 2, 2007

Related U.S. Application Data
(60) Provisional application No. 60/797,343, filed on May 2, 2006.

(51) Int. Cl. G06K 5/00; G06K 15/00; G07F 19/00

(52) U.S. Cl. 235/383; 235/379; 235/380

(57) ABSTRACT

A point of sale system is provided that can selectively control operation of one or more peripherals. The system includes a payment terminal with a reader for an electronic payment card and a port for communication with the peripheral. The system further includes a peripheral with a reader for the electronic payment card, and a monitor with a first port for coupling to the payment terminal and a second port for coupling to the payment device. The monitor includes a microcontroller providing for communication between the payment terminal and the peripheral, and the monitor determines an operational status of the peripheral. The monitor causes a redirection of communication as necessary based on the operational status of the peripheral.

### CROSS-REFERENCE TO RELATED APPLICATIONS

This application claims priority under 35 U.S.C. 119(e) to U.S. Provisional Patent Application No. 60/797,343 entitled “PAYMENT SYSTEM WITH OUTDOOR TERMINAL,” filed May 2, 2006, the disclosure of which is incorporated herein by reference.

### BACKGROUND

Retail locations, such as stores and restaurants typically provide a payment terminal where a customer can pay using a debit card, credit card, gift card, and other cards that are accepted for payment. Typically, such a point-of-sale (POS) terminal includes a card reader, a keypad, a display, and additional reprogrammable keys surrounding the display. The terminal typically also includes a communication capability, e.g., a serial port, a parallel port, Ethernet, or a wireless transceiver that links the terminal to a POS system, such as a PC-based cash register or other electronic cash register (ECR), so that the retailer can process the payment as part of its ongoing business. Quick-service restaurants often incorporate both an indoor customer service area and a drive-through window for customers to purchase meals either indoors or outdoors, typically from the customer's car.

### SUMMARY

The disclosed payment system with an outdoor terminal would be useful in a quick-service restaurant, where the outdoor terminal would be placed in the drive-through lane, but also may be incorporated in any other retail location. The payment system may incorporate a communication-control monitor that provides switching between point-of-sale devices and peripherals, depending upon their data packet identification and/or their device driver interfaces. The payment system may provide for connecting various payment devices, loaded remotely from the ECR or payment terminal, and may also provide for controlling the transmission of messages and signals between the various devices in the system. The monitor may also provide for an automated upload of software from an indoor payment terminal to the monitor and to the outdoor payment terminal without user intervention. The features of the present inventions will be understood more readily after a consideration of the drawings and the Detailed Description.

### BRIEF DESCRIPTION OF THE DRAWINGS

FIG. 1 is a block diagram of a payment processing system including a cash register coupled through a multiport cable to an indoor payment terminal and a monitor which connects to an outdoor payment terminal, and to a backup payment terminal.

FIG. 2 is a block diagram of the monitor.

FIG. 3 is a pictorial depiction of an embodiment of the payment processing system.

FIG. 4 is a pictorial depiction of an embodiment of the payment processing system.

FIG. 5 is a block diagram of the monitor or the payment processing system.

FIG. 6 is a pictorial depiction of an embodiment of a customer payment device for the payment processing system.

FIG. 7 is a pictorial depiction of an embodiment of a customer payment device for the payment processing system including a mounting bracket.

FIG. 8 is a pictorial depiction of an embodiment of a customer payment device for the payment processing system including a mounting bracket.

FIG. 9 is a pictorial depiction of an embodiment of a customer payment device for the payment processing system including a mounting bracket.

FIG. 10 is a pictorial depiction of an embodiment of a customer payment device for the payment processing system including a mounting bracket.

FIG. 11 is a pictorial depiction of three embodiment of customer payment devices for the payment processing system mounted adjacent a window in a drive-through lane of quick service restaurant.

### DETAILED DESCRIPTION

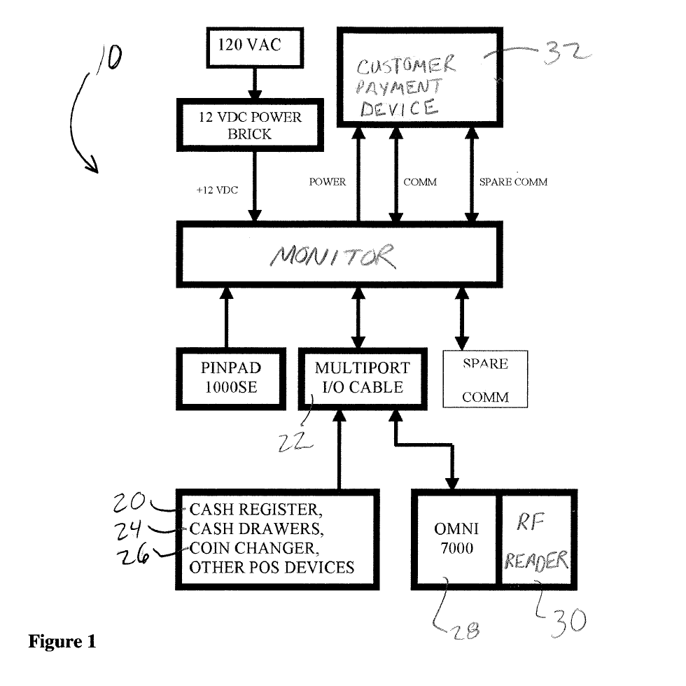

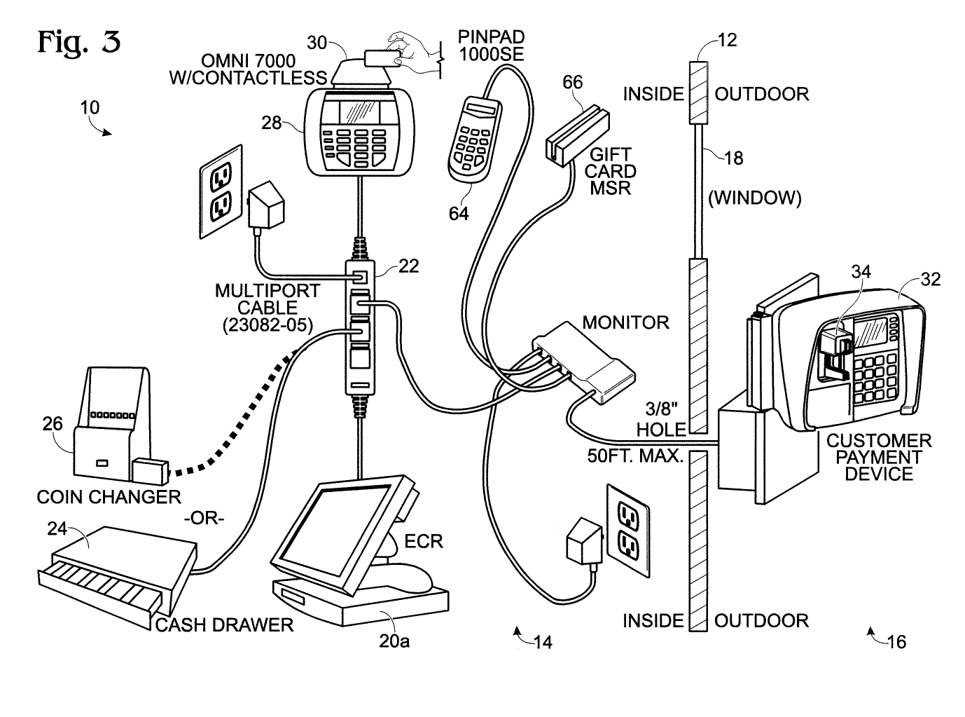

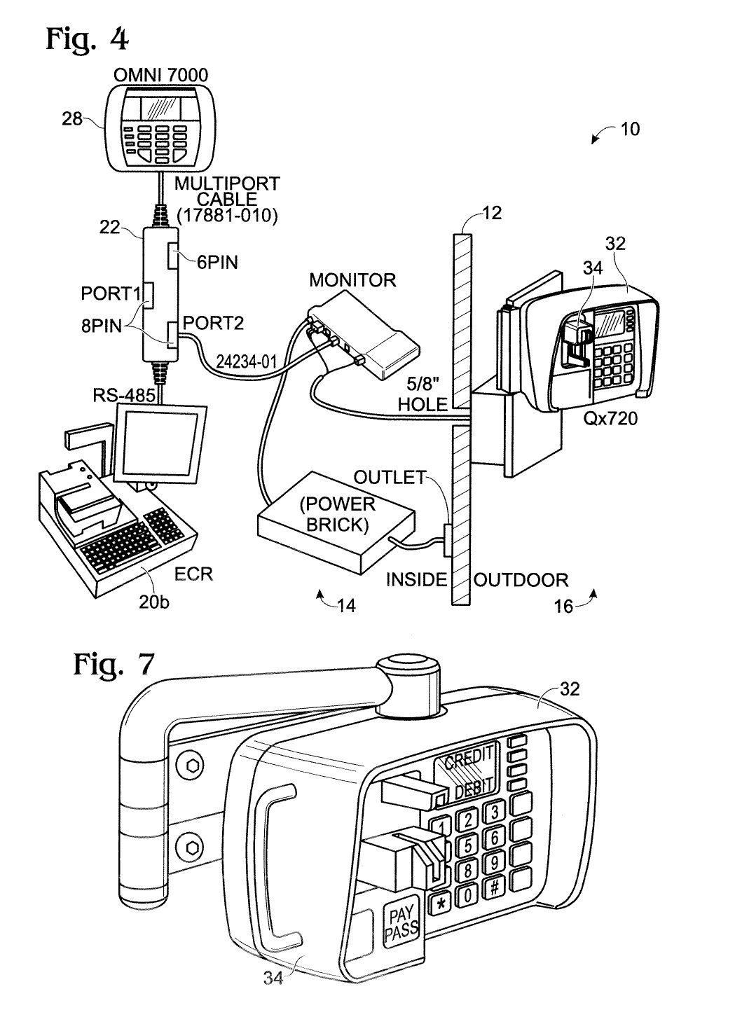

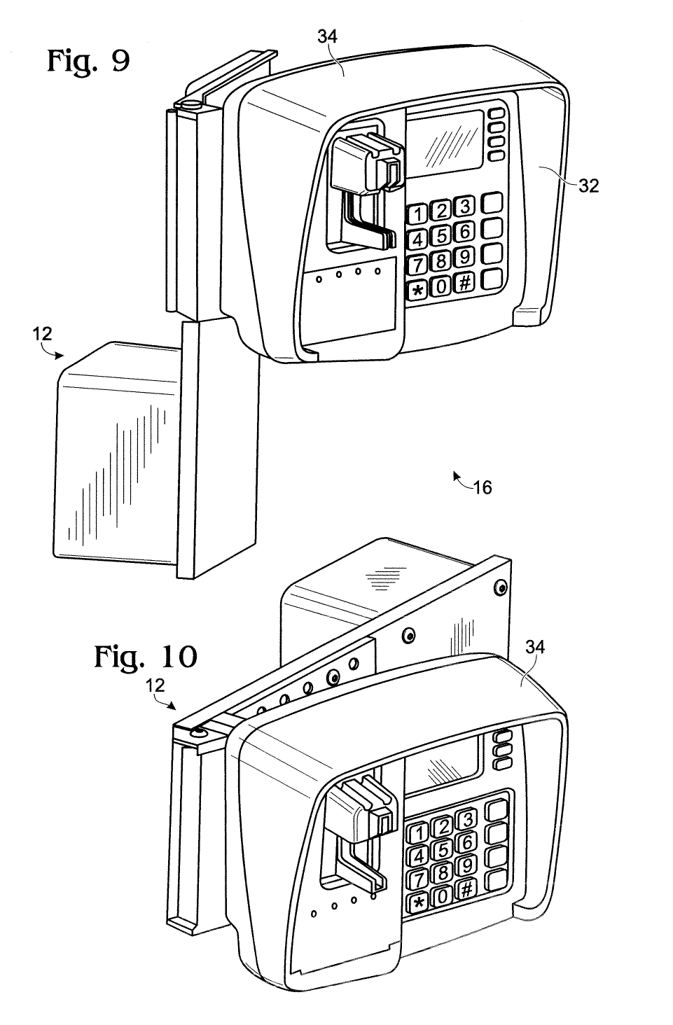

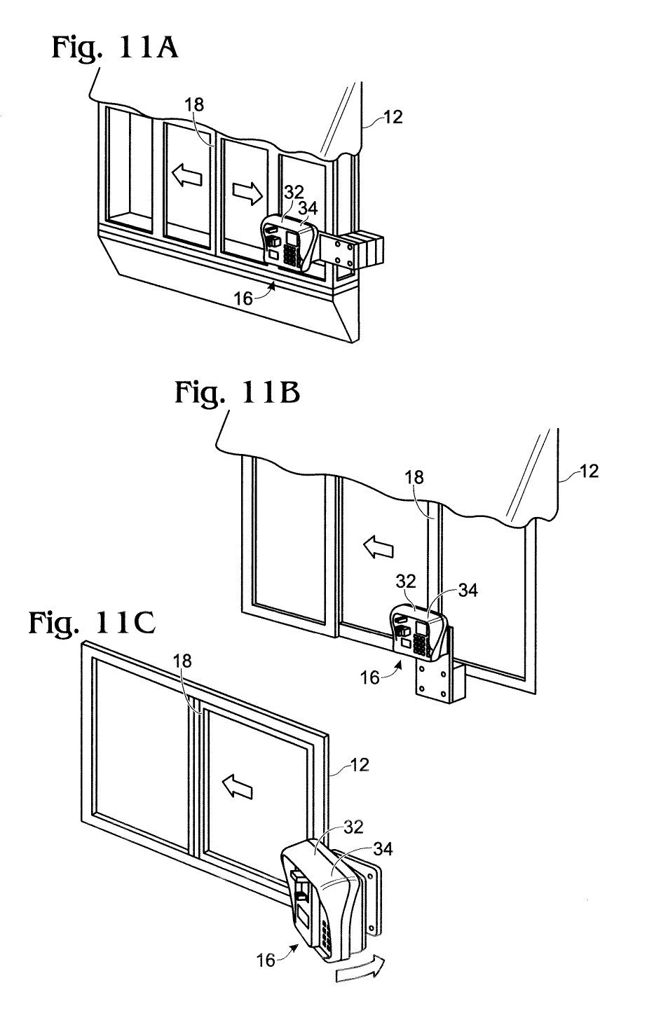

A payment processing system 10 is shown in FIGS. 1, 3, and 4. System 10 is typically for use in a quick service restaurant that includes a drive-through lane and a wall 12 that separates an indoor portion 14 of system 10 from an outdoor portion 16 of system (FIGS. 3, 4, and 9-11). The payment processing system may also be provided in any type of retail or other location where customers pay for goods or services, and all portions of the system may be indoors or outdoors, or the division between an indoor portion and an outdoor portion may be altered from that shown in the Figures. Wall 12 typically includes a window 18 that may be opened in the course of serving customers and closed to protect the inside of the restaurant.

System 10 typically includes an electronic cash register (ECR) 20, 20a, 20b that may be integrated into the operations of the retail location, e.g., providing automatic entry of menu items for both ordering and bill calculation purposes. The ECR typically includes a keypad or a touchscreen, a display, and associated electronics and may also include a card reader, a check reader, and other connected devices. The ECR is typically provided with an electrical connection to other devices in the system by a multiport cable 22 but may provided with any suitable type of connection. Cable 22 may also couple to a cash drawer 24 and/or a coin changer 26 and other devices.

A POS payment terminal 28, such as an Omni 7000 made by VeriFone, may also be coupled to the multiport cable or otherwise connected to the ECR for the handling of payments for goods and services by the customer. Payment terminal 28 is typically located indoors. The ECR or the payment terminal may be programmed and connected to a payment processor for the authorization of payments by customers using any of the typical cards, or checks. Payment terminal 28 typically includes a reader and processing capability for any magnetic card, such as credit cards, debit cards, prepaid cards, such as gift cards, or EBT cards, and may also include a contactless or RF card reader 30, made, e.g., by Vivotech.

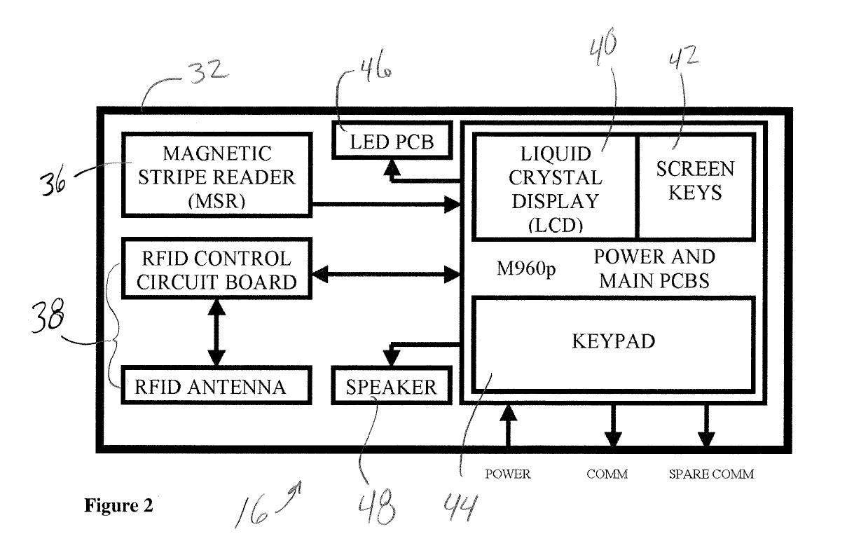

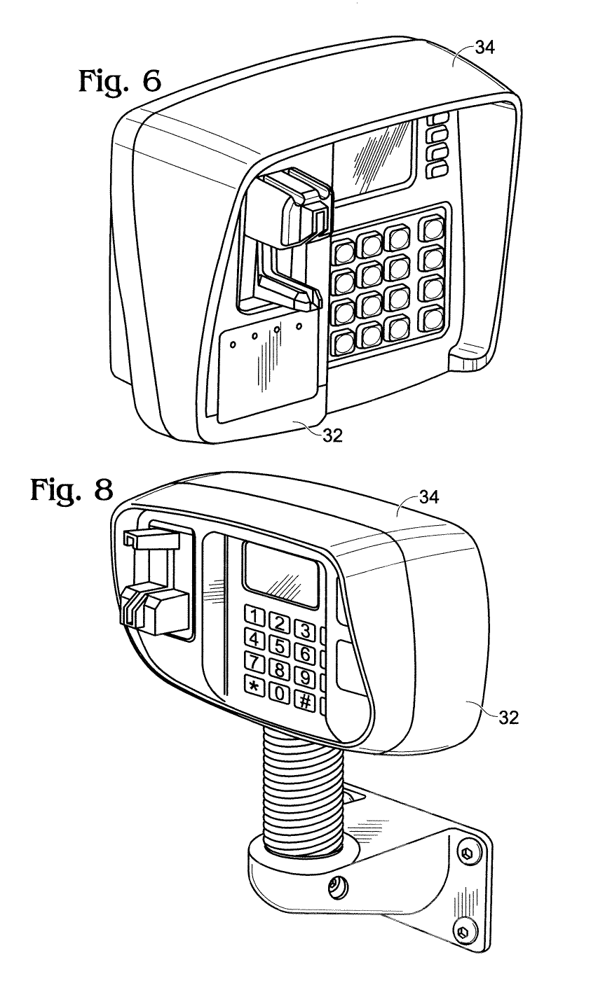

The outdoor portion 16 of the payment processing system typically includes a customer payment device 32 shown in block diagram in FIG. 2, and pictorially in FIGS. 3, 4, and 6-11. As noted above, customer payment device 32 is not required to be located outside. Customer payment device 32 may be provided with an enclosure 34, which may be water-resistant and provided with a heating system, a cooling system or fan, and a lamp as appropriate for the location of the enclosure. Typical dimensions for the enclosure are about 10-inches by about 7.5-inches by about 7.5-inches, but the enclosure may be designed for any reasonable dimensions as appropriate for the desired application. For outdoor applications, the payment device is ordinarily designed to operate in a temperature range from about −20° C. to about 50° C. and to withstand temperatures without damage from about −40° C. to about 60° C. The payment device is typically designed to operate in relative humidity from about 15% to about 90%, in a temperature range from about −5° C. to about 50° C.

The enclosure may be provided with protection from water in the forms of rain or washing spray from water jets in accordance with the IPX5 rating of the international standard IEC 60529, or in accordance with such other specification as is suitable for the desired application of the payment device.

Payment device 32 may include a magnetic stripe reader 36, a contactless reader 38, a display screen 40 with screen-addressable keys 42, and a keypad 44, typically with 12 or 16 keys of metal or other suitable construction. Reader 36 may be a swipe-style or a motorized device, or any suitable configuration, typically a dip-insertion style, with dual-track and bidirectional reading capability.

Keypad 44 may be coupled to an encryption device to secure PINs in an encrypted format for transmission to other components in the payment processing system. Typically keypad 44 is provided with a privacy shield to limit unwanted visual access to the customer's Personal Identification Number (PIN). Any appropriate encryption may be used, e.g., DES, 3DES, RSA, and/or AES in conjunction with a security module. Within payment device 32, communications between the keypad, display screen, and security module are typically safeguarded to prevent any unwanted detection or recording. All cryptography and key management functions (such as DUKPT or other suitable scheme) are typically performed by an integrated security chip.

Payment device 32 also typically includes LEDs 46 that indicate operational status of the contactless reader and/or other devices in the payment device. A speaker 48 may be incorporated in the payment device to provide the customer with audio instructions or information.

The messages displayed on screen 40, typically to instruct the customers in how to pay for a transaction, may include an option for selecting the language in which the messages are displayed. Display screen 40 maybe of any suitable size, definition, and rating, for example, a 128×64 pixel LCD with backlighting, sunlight-readable, and outdoor rated.

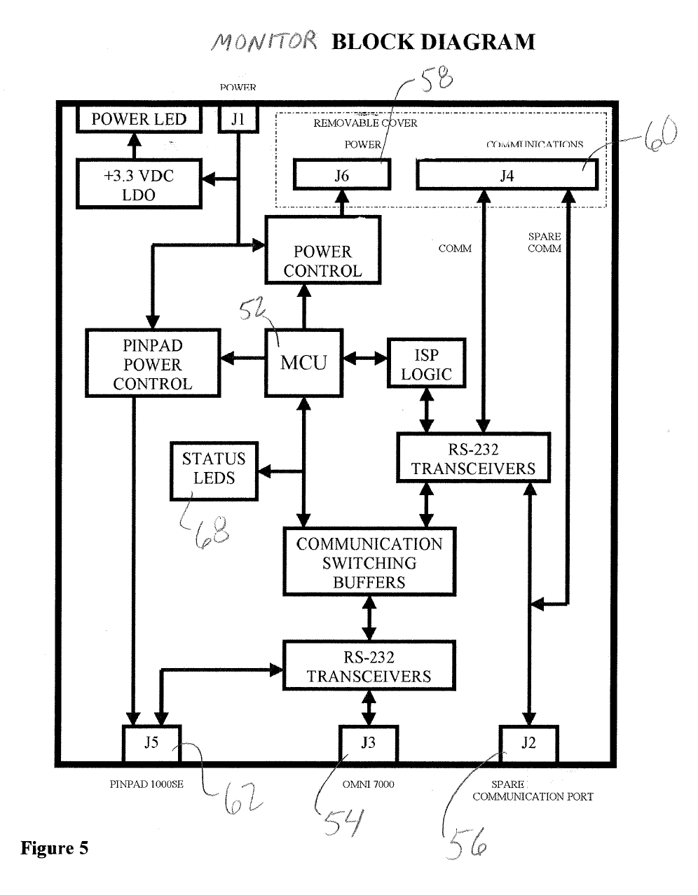

The ECR 20 and indoor payment terminal 28 are typically connected to the outdoor portion of the payment system by a monitor 50 that provides various capabilities. Monitor 50, as shown in FIG. 5 typically includes a microcontroller 52 which is programmed, typically in firmware, to provide for the communication between the devices in the payment system 10. Monitor 50 may include a port 54, typically RS-232, for connection to indoor payment terminal 28 via cable 22. Monitor 50 also may include one or more spare ports 56, which may be RS-232 or other types of ports, such as USB. Monitor 50 typically also includes a power connector 58 and communications connector 60 for coupling to the outdoor payment device. Monitor 50 may also include a port 62, RS-232 or otherwise, for connecting to a PINpad 64, such as VeriFone's PINpad 1000SE. The spare ports on monitor 50 may be used, e.g., for coupling a secondary magnetic stripe reader 66 for specialized use, such as with gift cards.

The monitor provides for expansion of the port capability of the payment terminal 28. The monitor allows the payment system to have one or more RS-232 serial port(s), using a suitable connector, e.g., RJ-45, and/or other types of ports, such as USB. The microcontroller firmware in the monitor analyzes packets coming from the payment terminal 28, and looks for packet headers. It redirects the message to the appropriate port based on commands or instructions in the header.

Monitor 50 may also include one or more status LEDs 68 for visual reporting of the status of the monitor and/or connected devices (e.g., power status and data communication status). Monitor 50 may also include power supplies, logic circuitry, and communications circuitry as appropriate for carrying out the herein described communication and control. Monitor 50 analyzes the message traffic in the payment system, such as messages between the indoor payment terminal and the outdoor payment device. If the outdoor payment device fails to respond appropriately, or otherwise indicates a lack of operational capability, monitor 50 can instruct the indoor payment terminal to redirect messages, e.g., to indoor PINpad 64, or monitor 50 can redirect messages to indoor PINpad 64 so that the customer can use PINpad 64 to complete a transaction. Monitor 50 may also poll the customer payment device and other devices in the system, in the absence or in conjunction with other message traffic, to determine the status of the devices and report the status or redirect messages based on the status.

The functionality of the indoor payment terminal may be incorporated into the cash register or other computer operating in the payment processing system.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements.

Inventions embodied in various combinations and subcombinations of features, functions, elements, and/or properties are claimed through presentation of the following claims. Such claims, whether they are directed to a different invention or directed to the same invention, whether different, broader, narrower or equal in scope to other claims, are also regarded as included within the subject matter of the inventions of the present disclosure.

We claim:

1. A point of sale system for receiving a payment from a customer using an electronic payment card and transmitting the payment to a payment processor, the system providing for selective control of operation of at least one peripheral in the system, the system comprising:
a payment terminal for handling the payment by the customer, wherein the payment terminal is configured to be programmed and connected to the payment processor, the payment terminal including a reader for the electronic payment card and a port for communication with the at least one peripheral;
at least one peripheral providing a payment device with a reader for the electronic payment card; and
a monitor including a first port for coupling to the payment terminal and a second port for coupling to the payment device, the monitor including a microcontroller providing for communication between the payment terminal and the at least one peripheral, wherein the monitor determines an operational status of the payment device, and the monitor causes a redirection of communication as necessary based on the operational status of the payment device.

2. The point of sale system of claim 1 wherein the monitor analyzes the communication between the payment terminal and the payment device and determines the operational status of the payment device from the communication from the payment device to the payment terminal.

3. The point of sale system of claim 1 wherein the monitor polls the payment device and determines the operational status of the payment device from the response of the payment device to such polling.

4. The point of sale system of claim 1 wherein the payment device includes a first PINpad, and the system further comprises a second peripheral providing a second PINpad, and wherein the monitor provides for redirection of communication to the second PINpad as necessary based on the operational status of the payment device.

5. The point of sale system of claim 1 wherein the monitor is coupled to at least two peripherals, and wherein communication is organized in a plurality of packets, each packet including a packet header, and wherein the monitor directs each packet to an appropriate one of the peripherals based on the header.

6. The point of sale system of claim 1 wherein the monitor includes at least one status LED for visual reporting of the status of the payment device.

7. The point of sale system of claim 1 wherein the electronic payment card is selected from the group consisting of credit cards, debit cards, gift cards, and EBT cards.

8. The point of sale system of claim 1 wherein the electronic payment card includes a magnetic stripe.

9. The point of sale system of claim 1 wherein the electronic payment card is a contactless RF card.

10. The point of sale system of claim 1 wherein the system includes an indoor portion and an outdoor portion, and the payment terminal is part of the indoor portion and the payment device is part of the outdoor portion.

11. The point of sale system of claim 1 wherein the monitor is coupled by a wireless connection to the payment device.

12. The point of sale system of claim 1 further comprising an electronic cash register (ECR) coupled to the payment terminal.

13. The point of sale system of claim 12 wherein the connection of the payment terminal to the payment processor is handled via the ECR.

14. The point of sale system of claim 12 wherein the payment terminal is integrated into the ECR.

15. The point of sale system of claim 1 wherein the monitor provides for coupling to at least three peripherals.

16. The point of sale system of claim 1 wherein the microcontroller in the monitor is programmed in firmware, and wherein the payment terminal and monitor further provide for automated upload of firmware to the monitor.

17. The point of sale system of claim 1 wherein the payment device is programmed in firmware, and wherein the payment terminal and monitor further provide for automated upload of firmware to the payment device.

18. A monitor for controlling communication to at least one peripheral in a point of sale system, wherein the system provides for receiving a payment from a customer using an electronic payment card and transmitting the payment to a payment processor, the system including a payment terminal for handling the payment by the customer, the payment terminal including a port for communication with the at least one peripheral, the monitor comprising:
a first port for coupling to the payment terminal and a second port for coupling to the at least one peripheral, the monitor including a microcontroller providing for communication between the payment terminal and the at least one peripheral, wherein the monitor determines an operational status of the at least one peripheral, and the monitor causes a redirection of communication as necessary based on the operational status of the at least one peripheral.

19. The monitor of claim 18 wherein the monitor analyzes the communication between the payment terminal and the at least one peripheral and determines the operational status of the at least one peripheral from the communication from the at least one peripheral to the payment terminal.

20. The monitor of claim 18 wherein the monitor polls the at least one peripheral and determines the operational status of the at least one peripheral from the response of the at least one peripheral to such polling.

21. The monitor for use in the point of sale system of claim 18 wherein the system includes at least two peripherals, and wherein communication is organized in a plurality of packets, each packet including a packet header, and wherein the monitor directs each packet to an appropriate one of the peripherals based on the header.

22. The monitor of claim 18 further comprising at least one status LED for visual reporting of the status of the at least one peripheral.

23. The monitor of claim 18 further including a wireless connection to the payment device.

24. The monitor of claim 18 wherein the monitor provides for coupling to at least three peripherals.

25. A point of sale system for operation at a retail location including an indoor area and an outdoor area, the point of sale system configured to receive a payment from a customer using an electronic payment card and transmit the payment to a payment processor, the point of sale system comprising:
(a) an indoor portion including:
a payment terminal for handling the payment by the customer, wherein the payment terminal is configured to be programmed and connected to the payment processor, the payment terminal including a reader for the electronic payment card and a port for communication with at least one peripheral; and
a monitor including a first port for coupling to the payment terminal and a second port for coupling to the at least one peripheral, the monitor including a microcontroller providing for communication between the payment terminal and the at least one peripheral, wherein the monitor determines an operational status of the at least one peripheral, and the monitor causes a redirection of communication as necessary based on the operational status of the at least one peripheral; and
(b) and an outdoor portion including:
a peripheral payment device with a reader for the electronic payment card.

26. The point of sale system of claim 25 wherein the payment device includes a display and a keypad with encryption.

27. The point of sale system of claim 26 wherein the display of the payment device is readable in direct sunlight.

28. The point of sale system of claim 26 wherein the reader includes a magnetic stripe reader and a contactless RF card reader.

29. The point of sale system of claim 25 wherein the payment device is mounted in an enclosure.

30. The point of sale system of claim 29 wherein the enclosure is provided with a lamp for illuminating a keypad of the payment device.

31. The point of sale system of claim 25 wherein the retail location includes a window between the indoor area and the outdoor area and the payment device includes a first PINpad, and the system further comprises a second peripheral providing a second PINpad in the indoor area adjacent the window, and wherein the monitor provides for redirection of communication to the second PINpad as necessary based on the operational status of the payment device.
